(19) United States
(12) Patent Application Publication
(10) Pub. No.: US 2014/0099018 A1
(43) Pub. Date: Apr. 10, 2014

(54) METHOD, SYSTEM, AND DEVICE FOR COMPRESSING, ENCODING, INDEXING, AND DECODING IMAGES

(71) Applicant: Umasankar Kandaswamy, Southfield, MI (US)

(72) Inventor: Umasankar Kandaswamy, Southfield, MI (US)

(21) Appl. No.: 14/049,947

(22) Filed: Oct. 9, 2013

Related U.S. Application Data
(60) Provisional application No. 61/711,476, filed on Oct. 9, 2012.

(51) Int. Cl. G06T 9/00

(52) U.S. Cl. CPC G06T 9/00
USPC 382/154

(57) ABSTRACT

A method for encoding image data, the method includes creating a plurality of textors from the image data; clustering the plurality of textors into a plurality of textor primatives; retrieving a learned image based on the plurality of textor primatives; and determining an error space based on a difference between the learned image and the plurality of textor primatives. A method for compressing, indexing, and decoding image data based on textors is also provided.

### BACKGROUND

This patent application claims priority to U.S. Provisional Application No. 61/711,476, filed Oct. 9, 2012, entitled “A Method, System, and Device for Compressing Encoding, Indexing, and Decoding Images,” now pending. This application contains the entire Detailed Description of U.S. patent application No. 61,711,476.

As digital photography becomes more prevalent due to the increase in popularity of smart phones and other devices with integrated digital imaging devices, the data amount transmitted due to the sharing of images increases. In addition, as the devices that incorporate image processing capabilities become more complex, i.e. due to the availability of features such as, auto-flash, high-capacity smarts cards, and mobile applications (apps) that allow integration between a user's personal data and a social networking site—the data amount transmitted also is increased. Thus, in order to decrease the data amount transmitted, various proposals have been developed.

By providing more efficient data transmission of images, a user may reduce the costs associated with the transmission of images. Further, content providers may provide content in a quicker and more efficient manner. Additionally, social networking sites may be able to generate greater revenues through a more efficient placement of advertisements.

In addition to providing more efficient data transmission, a user, a web site operator or application may also facilitate a faster search (indexing), of images and relevant data. Thus, software functionality such as facial recognition may be improved.

If efficient data transmission is not realized, a quality of service (QoS) provided by a mobile service provider or web site operator is hindered. Thus, customer satisfaction associated with the use of a product that transmits image data may be decreased.

### DESCRIPTION OF THE DRAWINGS

The detailed description refers to the following drawings, in which like numerals refer to like items, and in which:

FIG. 1 is a high-level block diagram illustrating an example computer;

FIG. 2 is a diagram illustrating a method of forming a textor vector;

FIG. 3 illustrates a method for extracting textor primitives and based on a provided features space, providing an error characterization;

FIG. 4 illustrates a method for encoding an image based on textors. In the encoding process, a system may be provided a new image; and

FIG. 5 illustrates a method for decoding an image encoded by a textor process.

### DETAILED DESCRIPTION

An image processing device, such as a digital camera, a smart phone with a digital camera, or the like, encodes, compresses, indexes and decodes image data. The methods, systems and devices disclosed herein are directed towards encoding, compressing, indexing and decoding data in a manner that utilizes various techniques to allow a user or system to optimize the data transmission in a predefined manner using textor vectors. A textor vector is a vector representation of a block of pixel values incorporating textural properties.

Methods, systems and devices are disclosed herein to encode, compress, index and decode image data utilizing successive approximate representations with textor vectors (TexSAR). Aspects disclosed below allow for TexSAR modeling to facilitate secure and efficient uploading and downloading of images via a mobile device. Thus, even in low-bandwidth conditions, image data may be efficiently transmitted to and from various communication devices.

Thus, if a picture is captured from an imaging device, with the concepts disclosed herein, the picture may be compressed and uploaded faster by using the techniques disclosed herein versus the picture being compressed and uploaded without relying on the techniques disclosed herein. Further, due to the aspects disclosed herein, an indexed image (i.e. an image stored in a database) may be searched and retrieved quicker than without using the techniques disclosed herein. For example, if a user captures an image of a coffee cup, due to the aspects disclosed herein, the user may retrieve all the pictures containing a similar looking coffee cup from a batch of images stored on a database.

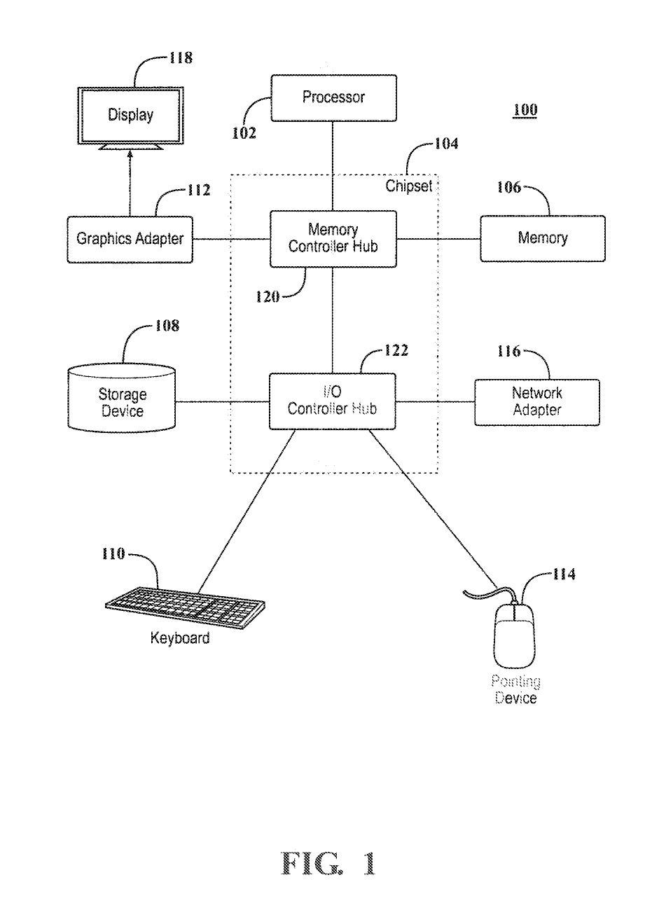

FIG. 1 is a high-level block diagram illustrating an example computer 100. The computer 100 may be embodied by a personal computer, a mobile terminal, or any device with a processor that processes and transmits image data. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer system 100. The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. For example, a video corpus, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

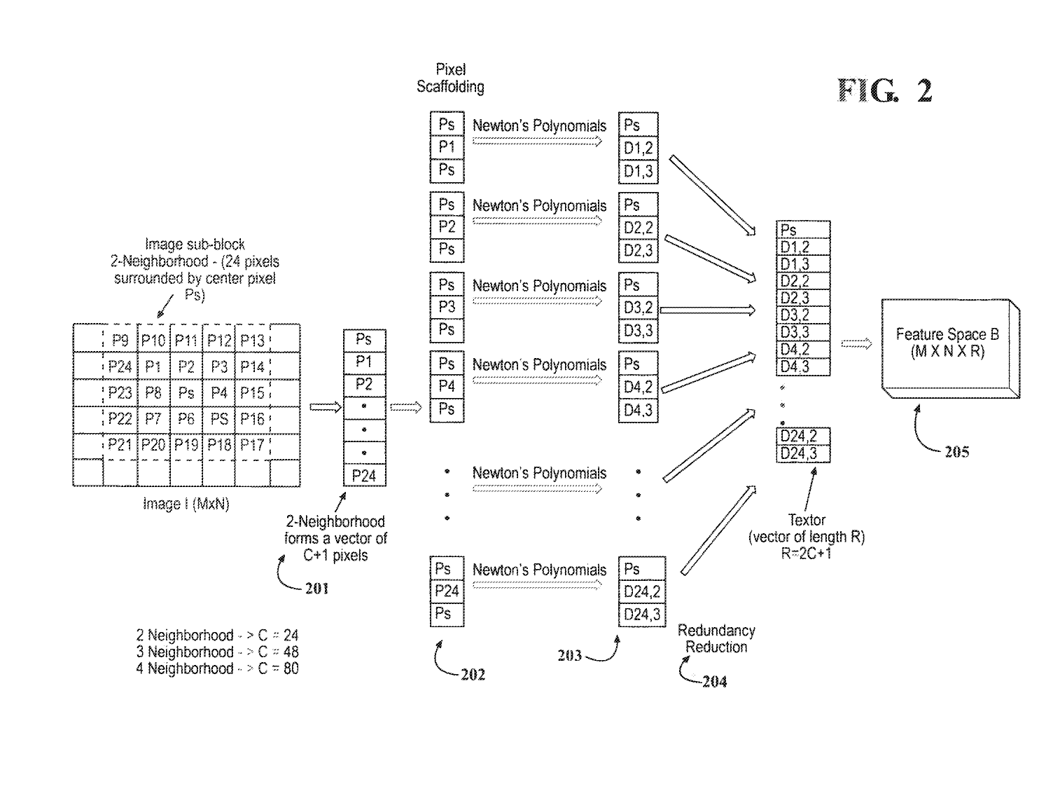

FIG. 2 is a diagram illustrating a method of forming a textor vector. Image data with an image plane sized M×N is provided. The image plane has a center pixel, Pₛ, with neighboring pixels, P₁, P₂, . . . , P_{C}, where C=8, 24, 48, 80 . . . C is dependent on the level chosen, with level 1 corresponding to a value of 8, level 2 corresponding to a value of 24, and so on.

In operation 201, a level is chosen. As shown in the FIG. 2, level 2 is chosen. Thus, image M×N has a center pixel, Pₛ, with neighboring pixels, P₁, P₂, . . . , P₂₄. As shown in FIG. 2, a vector of C+1 is created (in the example shown in FIG. 2 the vector is 25).

In operation 202, the center pixel P and its corresponding neighboring pixels are rearranged to form various sub-vectors. Each sub-vector represents an element of the vector from operation 201, sandwiched by duplicate copies of center pixel P. Thus, the resulting number of sub-vectors is C (or specifically, 24 in the example provided herein).

In operation 203, the sub-vectors of operation 202 undergo an extraction process to produce a Newton polynomial coefficient. The extraction process as described above is merely exemplary, and one of ordinary skill in the art may employ other extraction processes known in the art. Due to the extraction process, each of the sub-vectors has three elements, center point Pₛ, and two corresponding polynomial coefficients.

In operation 204, the sub-vectors of operation 203 are concatenated together. In concatenating the sub-vectors, the extraneous Pₛ elements are removed, thereby leading to a vector of length R (where R=2C+1). This factor of R will be used in numerous portions of this disclosure.

In operation 205, feature space (of dimensions M×N×R) is created partially from the textor created in operation 204. The textor created in operation 204 is one column of the feature space shown in FIG. 2. Various sub blocks of any given image may undergo the method described in FIG. 2 to create the feature space of multiple textors. A feature space is a 3-dimensional matrix of all the textors created for a given image.

Thus, using the method described in FIG. 2, a feature space of multiple textors for a given image is formed. As described below, the formation of a textor may facilitate various image processing techniques, such as image compression, encoding, decoding and indexing. Thus, the textor serves as a vector representation of a sub-block of a given image.

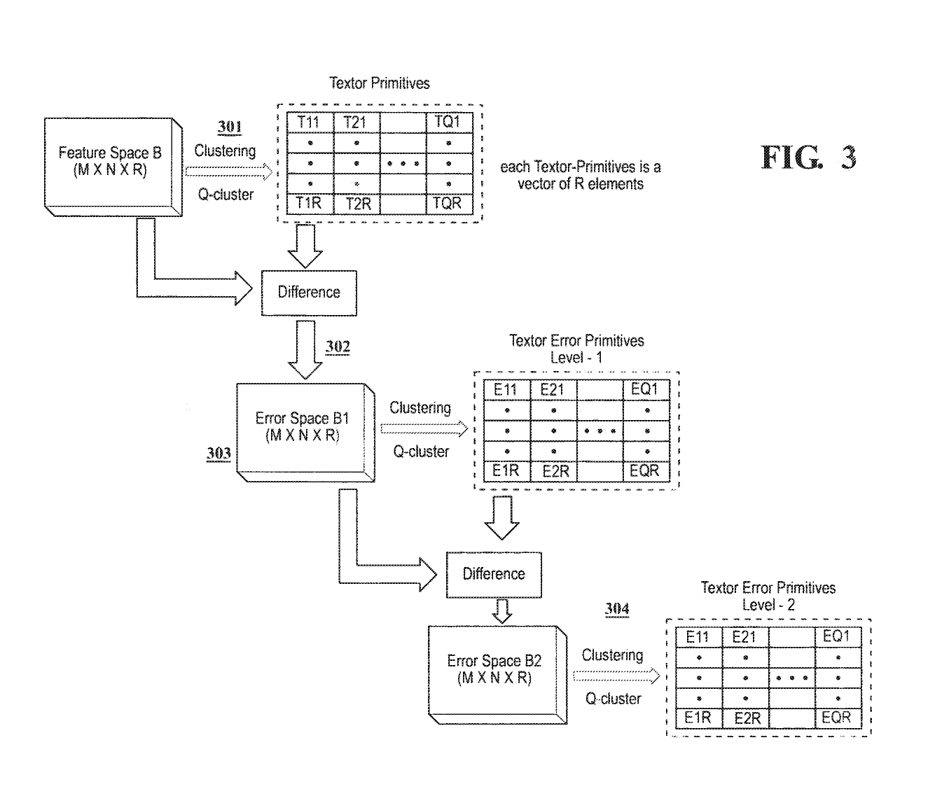

FIG. 3 illustrates a method for extracting textor primitives and based on a provided features space, providing an error characterization. As explained in FIG. 2, a feature space may be created. A feature space may be created for each learned image. A learned image is an image retrieved from a database or data store of images that a user or system may have access to. Thus, using the method according to FIG. 2, a feature space constructed of textors may be created for each learned image. According to the method described in FIG. 3, the textor primitives may be created for various error levels associated with a learned image. As shown in FIG. 3, two levels of error primitives are generated. The amount of error primitives created may be determined by a predefined amount chosen by a user, or a value such as the level used in the textor formation of FIG. 2.

In operation 301, a feature space is provided (for example, from the method described in FIG. 2). At operation 301, the various textors undergo a clustering through Euclidean distance measure (Q-cluster), thereby producing textor primitives. Through the clustering of the textors, similar textors may be grouped together. Once the various clusters are formed, a centroid for each cluster is determined.

In operation 302, a difference between the textor primitives and the provided feature space is produced. The difference between the various cluster elements and the determined cluster center represents the error in approximating a given textor by its representative cluster center. That is, if a column vector of length R in feature space M×N×R, for example, textor Fⁱ(r) {1<i<M×N, r=1, 2, R}where R=2C+1, is clustered into one of the Q-clusters, with cluster centers T_{q}^{l}(r) where l≦q≦Q, (l=0 since for the first level of clustering)—the error corresponding to any given textor Fᵣⁱ is defined as:

Eⁱ(r)=Fⁱ(r)−T_{q}⁰(r) (1)

in operation 303, an error space B1 is provided. Error space B1 is an approximation of the various errors created by the difference between the feature space and its clustered textor primitives (as calculated in operation 302). Error space B1 is used to model the characteristic error associated to replacing a given textor with its relevant (i.e. most similar) textor primitive.

In operation 304, a process similar to operations 301-303 is applied to error space B1. Thus, textor primitives and differences for each level between the generated textor primitives (from a higher level) and provided textors are created.

As shown in FIG. 3, an iterative process of various error spaces for each level is performed. In the example shown in FIG. 3, the level chosen was 2. The process of obtaining error vectors and cluster centers were repeated iteratively to quantify the error variations over multiple levels, thus forming textor and error primitive library (T_{α}^{l}(−), where l=0, 1, 2 . . . L). The number assigned to value L may be variable, with a higher level corresponding to more accurate compression. In addition, the variable Q may also affect the number of iterative processes performed.

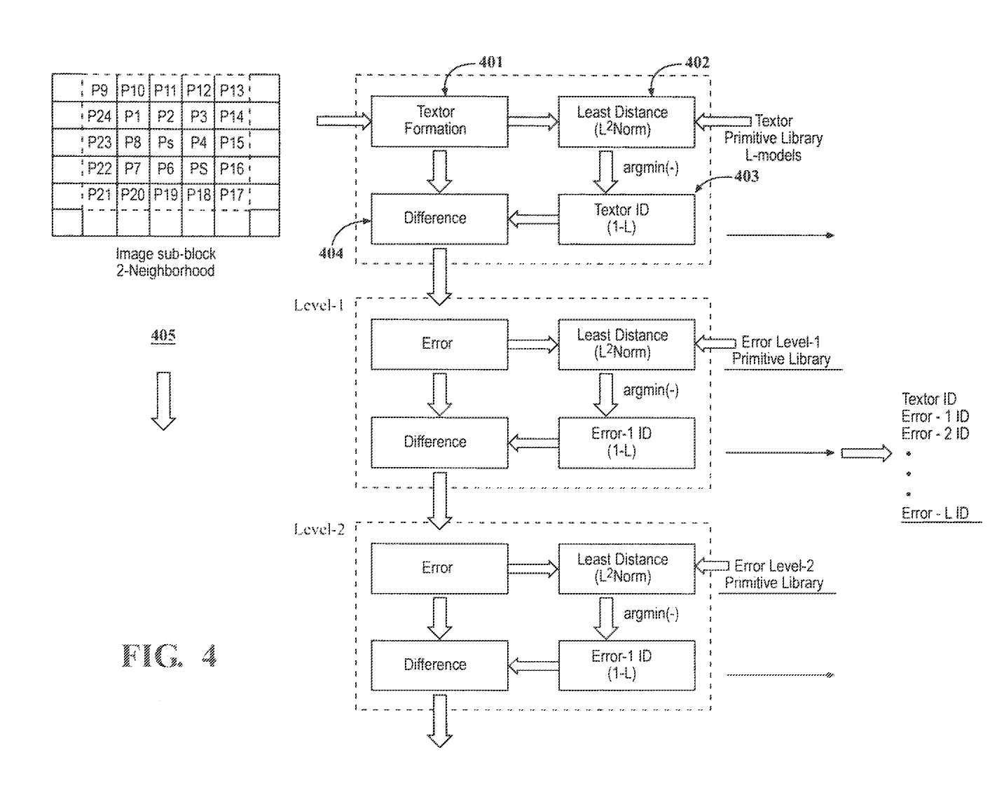

FIG. 4 illustrates a method for encoding an image based on textors. In the encoding process, a system may be provided a new image. The new image is encoded utilizing the learned images (and the associated error space creation described in FIG. 3).

In operation 401, a sub-block of the new image undergoes a textor formation (as described in FIG. 2). In this way, a feature space may be created for the new image to undergo an encoding process. The new image is divided into a number of non-overlapping sub-blocks. For example, sub-block u may form the textor gᵤ(r) with R elements. The number of elements in a sub-block is a function of sub-block size, which can be 5×5, 6×6, or 7×7 based on the neighborhood size C (2, 3, 4) chosen by the user. A neighborhood size may be chosen to ensure that the quality of the image in lossy compression mode is not worsened.

In operation 402, a learned image is acquired by searching for an image similar to the new image. By providing a learned image, various encoding and decoding techniques do not have to be repeated, as they were originally done for the learned image.

Specifically, textor gᵤ is compared with the textor primitives T_{q}^{l}(the library of textors that were acquired from the collection of learning images) and assigned an ID that corresponds to the index of the textor primitive that is most similar to the textor gᵤ. Mean squared error is used as the similarity measure for assigning the Textor ID:

$$M ( u , 0 ) = {arg min}_{q} [ \frac{1}{R} {\sum }_{r = 1}^{R} {( {g}_{u} ( r ) - {T}_{q}^{0} ( r ) )}^{2} ] \qquad ( 2 )$$

where, T_{q}⁰ with l=0 corresponds to Textor Level primitives.

At the end of operation 402, the argmin function described above retrieves a textor primitive from the learned images similar to the new image.

In operation 403, a textor from the new image is compared with a textor primitive from the learned image. Thus, an error can be produced. Specifically, a first level of an error between textor gᵤ and its most similar textor Primitive T_{M(u,0)}⁰ is measured as:

Eᵤ¹(r)=gᵤ(r)−T_{(M(u,0)}⁰(r) (3)

where r=1, 2, . . . , R.

In operation 404, the first level error is compared with error level-1 primitives, and assigned an ID that corresponds to the index of a similar primitive. M(u) for the first error level is calculates with the following expression:

$$M ( u , 1 ) = {arg min}_{q} [ \frac{1}{R} {\sum }_{r = 1}^{R} {( {E}_{u}^{1} ( r ) - {T}_{q}^{1} ( r ) )}^{2} ] \qquad ( 4 )$$

In operation 405, the operation is iteratively performed for multiple levels. This can be done based on a predefined value, a value set based on other variables used in the textor formation, or by a value chosen by a user. For example, a user can limit the levels used based on the amount of resources the user is willing to allocate to data storage. Thus, based on the method shown in FIG. 4, the following expression may represent the encoding:

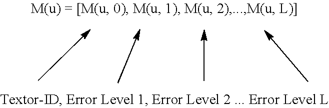

Thus, as stated above, by performing more iterations of the method described in FIG. 4, the encoding process is increased in accuracy. A user or a service provider can set the level of how accurate the image encoding/reproduction will be. For example, an image for medical imaging may require more detail, and thus, a user or service provider may set more iterations of the above-described process. On the contrary, an image shared between users of non-critical data, such as an image of a pet, may not require greater detail. Accordingly, a user can set the level, and subsequently the iterations performed, to a lesser value.

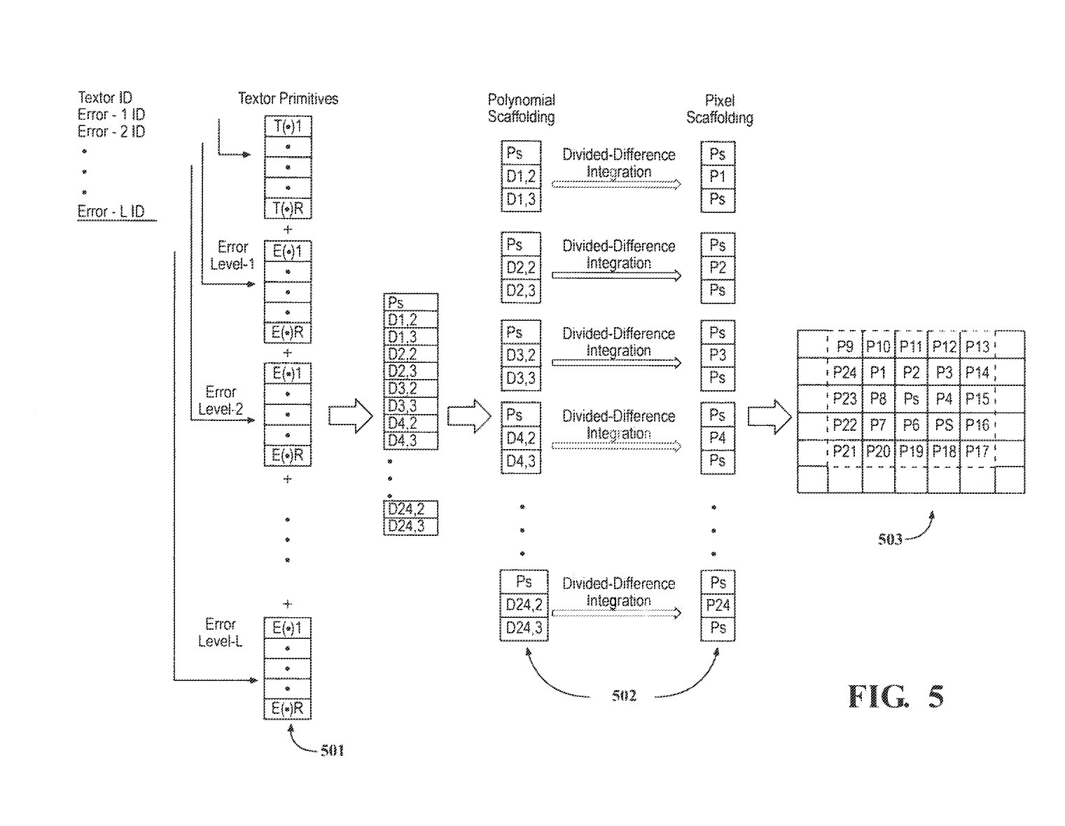

FIG. 5 illustrates a method for decoding an image encoded by a textor process. Thus, an image sub-block that has been encoded and represented as primitive IDs (see the method describe in FIG. 4) can be reconstructed back to pixel values by reversing the textor formation process.

In operation 501, a nearest form of approximations is collected from given encoded data and added to form one full textor: gᵤ=Σₗ^{L}T_{M(u.;)}^{l}. As shown in FIG. 5, the textor primitives are constructed into the vector shown as a result of operation 501.

In operation 502, the gᵤ is separated into various sub-vectors and integrated to form the original pixel values. As shown in FIG. 5, a set of sub-vectors separated via polynomial scaffolding undergo a transformation to result in various pixel scaffolding vectors.

In operation 503, the pixel values are re-arranged to form the image sub block. Thus, the encoded data (encoded via textor formation) results in a reconstructed image via textor decoding.

The above-described examples may be implemented as non-transitory computer-readable codes in computer-readable recording media. The computer-readable recording media includes all kinds of recording devices that store data readable by a computer system.

Examples of computer-readable media include ROM, RAM, CD-ROM, magnetic tapes, floppy disks, optical disks and the like. Also, the computer-readable media may be implemented with the form of carrier wave (for example, transmission through the Internet). In addition, a computer-readable storage medium may be distributed among computer systems connected through a network and computer-readable codes or program instructions may be stored and executed in a decentralized manner. Also, functional programs, codes and code segments for accomplishing the present invention can be easily construed by programmers skilled in the art to which the present invention pertains.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method for forming a vector for an M×N image, comprising:
selecting a level to analyze a center pixel of the M×N image;
creating a plurality of sub-vectors based on the center pixel and the center pixel's neighboring pixels;
extracting the center pixel, a first polynomial and a second polynomial for each of the plurality of sub-vectors;
removing the center pixel from each of the plurality of sub-vectors; and
creating a three-dimensional feature space from the center pixel.

2. The method of claim 1, wherein the three-dimensional feature space is partially defined dimensionally by an R component, the R component being defined by a number of the plurality of sub-vectors created.

3. A method for encoding an M×N image, comprising:
clustering a plurality of vectors from a three-dimensional feature space to produce a plurality of vector primitives;
calculating a difference between the plurality of vector primitives and the feature space to create an error space; and
iteratively performing the clustering and the calculating on the error space.

4. The method of claim 3, wherein the three-dimensional feature is produced by the following:
performing a textor formation on the M×N image;
providing a learned image based on the textor formation;
producing an error based on the learned image; and
creating an index of the M×N image based on comparing the error with an error level-1 primitives.

5. The method of claim 3, wherein the textor formation is produced by the following:
selecting a level to analyze a center pixel of the M×N image;
creating a plurality of sub-vectors based on the center pixel and the center pixel's neighboring pixels;
extracting the center pixel, a first polynomial and a second polynomial for each of the plurality of sub-vectors;
removing the center pixel from each of the plurality of sub-vectors; and
creating a three-dimensional feature space from the center pixel.

6. The method of claim 5, further comprising an iterative process for a plurality of predetermined levels.

7. The method of claim 6, wherein the predetermined level is settable per image.

8. The method of claim 7, wherein the textor primitives are stored in a library of textor primitives.

9. The method of claim 2, wherein the three-dimensional feature space is partially defined dimensionally by an R component, the R component being defined by a number of the plurality of the sub-vectors created.

10. A method for decoding a textor encoded image, comprising:
forming a textor vector from the textor encoded image;
separating the textor vector into a plurality of sub-vectors to form the original pixels of the textor encoded image; and
re-arranging the original pixels to form the image.

11. The method of claim 9, wherein the textor encoded image is produced by:
clustering a plurality of vectors from a three-dimensional feature space to produce a plurality of vector primitives;
calculating a difference between the plurality of vector primitives and the feature space to create an error space; and
iteratively performing the clustering and the calculating on the error space.

12. The method of claim 11, wherein the three-dimensional feature is produced by the following:
performing a textor formation on an M×N image;
providing a learned image based on the textor formation;
producing an error based on the learned image; and
creating an index of the M×N image based on comparing the error with an error level-1 primitives.

13. The method of claim 12, wherein the textor formation is produced by the following:
selecting a level to analyze a center pixel of the M×N image;
creating a plurality of sub-vectors based on the center pixel and the center pixel's neighboring pixels;
extracting the center pixel, a first polynomial and a second polynomial for each of the plurality of sub-vectors;
removing the center pixel from each of the plurality of sub-vectors; and
creating a three-dimensional feature space from the center pixel.

14. The method of claim 13, wherein the creating of the index further comprises an iterative process for a plurality of predetermined levels.

15. The method of claim 14, wherein the predetermined level is settable per image.

16. The method of claim 15, wherein the textor primitives are stored in a library of textor primitives.

17. The method of claim 11, wherein the three-dimensional feature space is partially defined dimensionally by an R component, the R component being defined by a number of the plurality of sub-vectors created.
